(19) United States
(12) Patent Application Publication
(10) Pub. No.: US 2023/0381646 A1
(43) Pub. Date: Nov. 30, 2023

(54) ADVANCED STEREOSCOPIC RENDERING

(71) Applicant: INNOPEAK TECHNOLOGY, INC., Palo Alto, CA (US)

(72) Inventors: Hongyu Sun, Palo Alto, CA (US); Chen Li, Palo Alto, CA (US); Chengeng Li, Palo Alto, CA (US); Zhebin Zhang, Palo Alto, CA (US); Xiaoyu Ye, Palo Alto, CA (US); Daniel Thornton, Palo Alto, CA (US)

(21) Appl. No.: 18/233,056

(22) Filed: Aug. 11, 2023

Related U.S. Application Data
(63) Continuation of application No. PCT/US2021/019240, filed on Feb. 23, 2021.

(51) Int. Cl. A63F 13/52; H04N 13/271; H04N 13/128; G06T 15/00; G06T 1/20

(52) U.S. Cl. CPC A63F 13/52; H04N 13/271; H04N 13/128; G06T 15/005; G06T 1/20; H04N 2013/0081

(57) ABSTRACT

Systems and methods are provided for an advanced stereoscopic 3D rendering system to solve several of these 3D rendering issues and work independently of different game engines. For example, the system can include a stereoscopic render mechanism to apply post-processing effects to OpenGL ES applications. The advanced stereoscopic 3D rendering system can be added as an interception layer between the game engine and the display screen of the user. This interception layer can be integrated with many different game engines to create a 3D view for various user device models, thus removing the need for image generators at the user device to create 3D images. The 3D images can be created by the advanced stereoscopic 3D rendering system for viewing by the end user and seemingly incorporated with the game or other software application.

### CROSS-REFERENCE TO RELATED APPLICATION

This application is a continuation of International Application No. PCT/US2021/019240, filed on Feb. 23, 2021, the entire contents of both of which are incorporated herein by reference.

### TECHNICAL FIELD

The present disclosure relates to the field of imaging technologies, and more particularly, to advanced stereoscopic rendering.

### BACKGROUND

Many current imaging technologies are limited to two dimensional (2D) images. When different images are needed, like the generation and transmission of three dimensional (3D) images, the backend platform responsible for generating the imaging often needs complete retooling. Existing platforms have trouble generating and storing these 3D images. Additionally, even when these improvements are made to the platform, limitations are insurmountable at the receiving device due to the resource constraints. These constraints manifest themselves in such features as small screen sizes, limited processing power, small memory footprints, and critical power consumption. Better systems are needed.

### SUMMARY

This summary section is provided in order to simply present the ideas which will be described in detail hereinafter in the detailed description section. The summary section is not intended to identify key features or essential features of the claimed technical solutions, nor is it intended to limit the scope of the claimed technical solutions.

In a first aspect, the present disclosure provides a computer-implemented method. The computer-implemented method includes: receiving rendering parameters provided as part of a modified OpenGL pipeline in an interception layer to an original application; generating an application call request to an effect loader and an effect shader; in response to the application call request, receiving an application call response for a left output and a right output; and transmitting the left output and the right output to an OpenGL application programming interface (API) to create a three-dimensional (3D) rendered image in the original application.

In a second aspect, the present disclosure provides a computer system for generating a three-dimensional (3D) rendered image. The computer system includes a memory and one or more processors. The one or more processors are configured to execute machine readable instructions stored in the memory to: receive rendering parameters provided as part of a modified OpenGL pipeline in an interception layer to an original application; generate an application call request to an effect loader and an effect shader; in response to the application call request, receive an application call response for a left output and a right output; and transmit the left output and the right output to an OpenGL application programming interface (API) to create the 3D rendered image in the original application.

In a third aspect, the present disclosure provides a non-transitory computer-readable storage medium. The non-transitory computer-readable storage medium stores a plurality of instructions executable by one or more processors. The plurality of instructions when executed by the one or more processors cause the one or more processors to: receive rendering parameters provided as part of a modified OpenGL pipeline in an interception layer to an original application; generate an application call request to an effect loader and an effect shader; in response to the application call request, receive an application call response for a left output and a right output; and transmit the left output and the right output to an OpenGL application programming interface (API) to create the 3D rendered image in the original application.

Other features and advantages of the present disclosure will be described in detail in the subsequent detailed description.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 provides illustrations of an advanced stereoscopic 3D rendering system, in accordance with embodiments of the application.

FIG. 2 provides illustrations of a game architecture at the user device, in accordance with embodiments of the application.

FIG. 3 illustrates the advanced stereoscopic 3D rendering system, in accordance with embodiments of the application.

FIG. 4 illustrates an original image, in accordance with embodiments of the application.

FIG. 5 illustrates an anaglyph image, in accordance with embodiments of the application.

FIG. 6 illustrates a side-by-side image, in accordance with embodiments of the application.

FIG. 7 illustrates an interlaced image, in accordance with embodiments of the application.

FIG. 8 illustrates a 2*2 H4V format image, in accordance with embodiments of the application.

FIG. 9 illustrates providing each image type from a data format to a corresponding user device, in accordance with embodiments of the application.

FIG. 10 provides an illustrative disparity calculation, in accordance with embodiments of the application.

FIG. 11 illustrates a computing component for providing stereoscopic rendering, in accordance with embodiments of the application.

FIG. 12 is an example computing component that may be used to implement various features of embodiments described in the present disclosure.

The figures are not exhaustive and do not limit the present disclosure to the precise form disclosed.

### DETAILED DESCRIPTION

Embodiments of the application can provide a stereoscopic rendering mechanism for generating 3D images on user devices (e.g., mobile phones, etc.). This allows the user device to present a 3D effect that was not included in the original software application. This new 3D effect can improve the user experience and add functionality to the application in post-processing that was not originally provided by the software developer.

Specifically in the mobile gaming environment, mobile gaming has improved by leaps and bounds, yet mobile phone user devices are still constrained by small screen sizes, limited processing power, small memory footprints, and critical power consumption. Many of the games delivered on the mobile platforms have been restricted to 2D games, 3D-look-like games (i.e. not true 3D), or games with very poor 3D effects. This is simply because implementing fully 3D-featured mobile games on user devices has never been an easy task. In fact, advanced 3D graphics techniques are widespread in the games market (PC and console) but true 3D in mobile games is limited.

In some examples, a depth-image-based rendering (DIBR) algorithm can be used to generate and transmit “virtual” stereoscopic 3D images. DIBR is the process of synthesizing “virtual” views of a scene from still or moving images and associated per-pixel depth information. This improves an electronic generation of a 3D image at the user device using a two-step process. First, the original 2D image points are re-projected into the 3D world, utilizing the depth and texture data. Second, these 3D points are projected into the image plane of a “virtual” camera, which is located at the required viewing position. The concatenation of reprojection (2D-to-3D) and subsequent projection (3D-to-2D) is usually called 3D image warping.

However, standard 3D image warping is based on a specific platform for a specific data format. It could be overwhelming for a software developer to add old functionalities from old platforms to the new 3D enabled platform for each of the various mobile games, since the developers would also need to generate new applications and functions to support the game engine. Therefore, the solution for cross game engine development has been a difficult problem to solve.

Other issues in the 3D rendering process involve how to improve the user experience. In standard systems, a disparity computation is needed to generate stereo images in the 3D rendering. However, it is not easy to compute the disparity of different views when there is not enough information associated with the application, such as pixel depth of field and scaling, which could have been collected by the original software developer, but are difficult to collect in post-processing. Also, due to the high discontinuities at a border of a 2D image, contour artifacts may be generated in the 3D images, which makes the alignment and calibration important yet incredibly difficult to determine.

Embodiments of the present disclosure include an advanced stereoscopic 3D rendering system to solve several of these 3D rendering issues and work independently of different game engines. For example, the advanced stereoscopic 3D rendering system can include a stereoscopic render mechanism to apply post-processing effects to OpenGL ES applications. The advanced stereoscopic 3D rendering system can be added as an interception layer between the game engine and the display screen of the user. This interception layer can be integrated with many different game engines to create a 3D view for various user device models, thus removing the need for image generators at the user device to create 3D images. The 3D images can be created by the advanced stereoscopic 3D rendering system for viewing by the end user and seemingly incorporated with the game or other software application.

In some examples, the advanced stereoscopic 3D rendering system can provide two different pipelines, single rendering pipeline and dual rendering pipeline, for different game engines. The use of either the single rendering pipeline or the dual rendering pipeline may depend on the game engine that generated the initial 2D images. The advanced stereoscopic 3D rendering system can generate a different 3D data format for each user device (e.g., anaglyph, side-by-side, interlace, 2*2 hydrogen 4-view (H4V) format, etc.). The use of the single rendering pipeline or the dual rendering pipeline can enable the 3D effect for games irrespective of whether the game engine supports the 3D images originally.

Additionally, the advanced stereoscopic 3D rendering system can calibrate the 3D images using an improved disparity measurement. To get more accurate disparity, the disparity may be calibrated. In some examples, the disparity may be calibrated using a view distance between eye and screen using a tracking and detection module for devices with front camera. For user devices without a front camera, a reset module may be incorporated to adjust the view distance.

The 3D image may be further improved by incorporating one or more filters. For example, to align the edge of the 3D image, a guided filter may be used to remove any large gradient differences and preserve the edge information.

Technical improvements are realized throughout the application. For example, the image processing at the user device can be adjusted from the original 2D image data to a 3D image, without transmitting the larger size 3D images over a communication network. This may reduce the amount of data transmitted to the user device and via the communication network, leaving bandwidth available for transmitting other bitstreams of data.

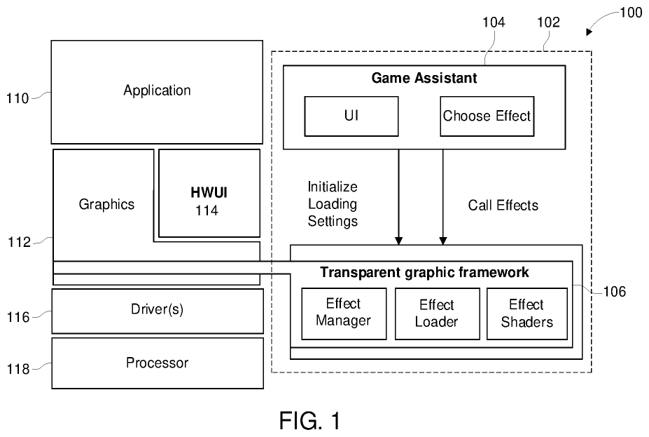

FIG. 1 provides illustrations of an advanced stereoscopic 3D rendering system, in accordance with embodiments of the application. In illustration 100, advanced stereoscopic 3D rendering system 102 is provided to a user device among its computational layers, including application 110, graphics 112, HWUI 114, driver(s) 116, and processor 118. For example, application 110, graphics 112, HWUI 114, driver(s) 116, and processor 118 may be embedded with the user device to generate a mobile gaming environment, and can be implemented in different environments using features described throughout the disclosure.

Application 110 may comprise a software application executed using computer executable instructions on the user device. Application 110 may interact with the user interface of the user device to display received information to the user. In some examples, application 110 may include an electronic game or other software application that is operated by the user device to provide images via the display of the user device.

Graphics 112 may comprise a computer graphics rendering application programming interface (API) for rendering 2D and 3D computer graphics (e.g., OpenGL for Embedded Systems, OpenGL ES, GLES, etc.). Graphics 112 may be designed for embedded systems like smartphones, video game consoles, mobile phones, or other user devices.

HWUI 114 may include a library that enables user interface (UI) components to be accelerated using the processor 118 (e.g., GPU, CPU, etc.). HWUI 114 may correspond with an accelerated rendering pipeline for images and other data. In some user device models (e.g., non-Android® models, etc.), HWUI 114 may be removed without diverting from the essence of the disclosure.

Driver(s) 116 may comprise a computer program that operates or controls the processor 118 by providing a software interface to a hardware device. Driver(s) 116 may enable the operating system of the user device to access hardware functions without encoding precise details about the hardware being used.

Processor 118 may include a specialized hardware engine to execute machine readable instructions and perform methods described throughout the disclosure. In some examples, processor 118 corresponds with a Graphics Processing Unit (GPU) to accelerate graphics operations and/or perform parallel, graphics operations. Other processing units may be implemented without diverting from the scope of the application (e.g., central processing unit (CPU), etc.).

Advanced stereoscopic 3D rendering system 102 can be provided as an interception layer between mobile game related libraries and drivers at graphics 112. Advanced stereoscopic 3D rendering system 102 may be invoked when an interface tool is activated (e.g., selecting “activate” or providing a predetermined visual effect from the UI in game assistant, etc.).

In some examples, when advanced stereoscopic 3D rendering system 102 is invoked or enabled, the predefined graphics 112 may be intercepted and a customized graphics layer may be provided in its place. Through this interception, advanced stereoscopic 3D rendering system 102 may modify the a normal layer behavior of graphics 112 (e.g., modify OpenGL by using Android® 10+ GLES Layers system, etc.). Once the graphics layer is modified with supporting 3D effects, advanced stereoscopic 3D rendering system 102 may recompile it to use with application 110. For example, the predetermined effect may generate a left output and a right output to create a 3D image, which is transmitted an OpenGL application programming interface (API) to create a three-dimensional (3D) rendered image in application 110. Advanced stereoscopic 3D rendering system 102 may be installed on the user device as a transparent graphic framework.

The interception layer may correspond with a post-processing mechanism that does not depend on the game engine. Advanced stereoscopic 3D rendering system 102 may comprise two pipelines, single rendering pipeline and dual rendering pipeline. For games that do not originally support 3D image effect, use of advanced stereoscopic 3D rendering system 102 can get a new view by dynamically shifting the virtual camera in the game engine.

Various system properties may be altered as well. For example, the “debug.gles.layers” system property may be changed to reference a parameter associated with advanced stereoscopic 3D rendering system 102. This parameter may redirect processing from the predefined application to advanced stereoscopic 3D rendering system 102. This may effectively cause application 110 to call a specific OpenGL wrapper of advanced stereoscopic 3D rendering system 102 instead of the default implementation. Once advanced stereoscopic 3D rendering system 102 provides the parameter and redefined function calls, the application may forward the processing back to the default implementation of OpenGL.

Game assistant 104 may comprise a user interface where users could interactively choose effects or turn on/off the effects. The interactions may be received at a user interface of a user device and processed by game assistant 104.

When turning on one or more effects, game assistant 104 may initialize load settings to transparent graphic framework 106. The load settings may be predetermined and stored in a data store. Game assistant 104 may access the data store and retrieve the load settings that correspond with the chosen effect.

Game assistant 104 may also be configured to execute machine readable instructions to initiate or call the effects requested by users at transparent graphic framework 106.

Transparent graphic framework 106 may include an effect manager, effect loader, and effect shader.

The effect manager can toggle on and off the 3D effects at advanced stereoscopic 3D rendering system 102. To toggle these 3D effects, the effect manager may pass particular parameters to the effect loader that correspond with the particular 3D effect. The 3D effects may include, for example, lights, wire mesh frames, tiles, animation, image perspectives, materials, textures, or other image wrappers and libraries.

The effect loader may comprise a 3D library of 3D objects. Shades, shadows, and directional light corresponding with generating 3D images may also be stored with the 3D library.

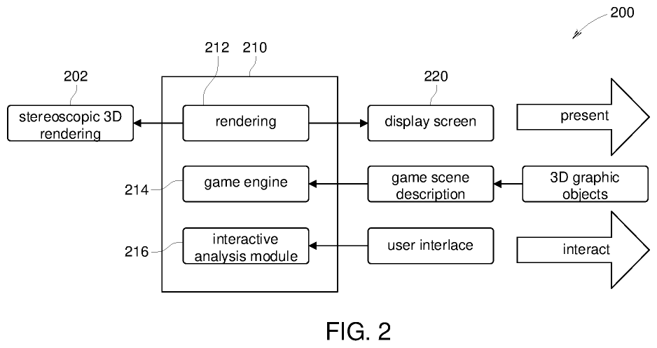

The effect shader may comprise a specific shader to implement rendering and generate 3D effects for various 3D formats. Additional detail regarding the rendering and 3D image effects is provided with FIG. 2.

FIG. 2 provides illustrations of a game architecture at the user device, in accordance with embodiments of the application. User device 200 may download or otherwise obtain various engines or modules 210, including rendering engine 212, game engine 214 (or other software application), and interactive analysis module 216.

Rendering engine 212 may provide data to stereoscopic 3D rendering engine 202 in advanced stereoscopic 3D rendering system 102. Output from rendering engine 212 may be provided to the display screen 220 of user device 200. Display screen may present the rendered images at user device 200.

Different rendering formats of 3D images, including the effect loader and effect shader, may be generated in consideration of a layout of the user's eyes using a disparity measurement. For example, human eyes may be assumed to be horizontally separated by about 50-75 mm (as an interpupillary distance). This may cause each eye to have a slightly different view of the world around it, which can easily be seen when alternately closing one eye while looking at a vertical edge. The disparity can be observed from apparent horizontal shift of the vertical edge between both views. This disparity measurement can be correlated to an offset of stereo images taken from a set of stereo cameras. The variable distance between the set of stereo cameras (e.g., baseline) can affect the disparity measurement of a specific point on its respective image plane. As the baseline increases, the disparity measurement increases due to the coordinate difference of the point between the right and left images.

To generate a synthesized view for 3D rendering, depth of each fragment piece may be utilized to compute the relative disparity on a screen of a user device. The depth can be either retrieved directly from a buffer associated with the processor (e.g., GPU buffer, etc.) by an OpenGL built-in extension or can be captured as a texture and parsed to the effect shader for further usage.

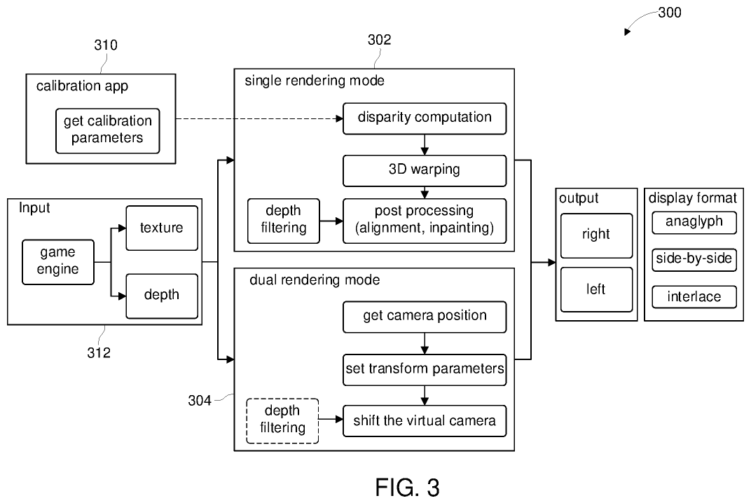

In some examples, the disparity computation is implemented with a single rendering mode. The single rendering mode is provided in more detail in FIG. 3.

Game engine 214 may receive game scene description data from an original game developer. This data may be provided by an exterior module, based on 3D graphics objects. 3D graphics objects can be provided to the user interface that have been developed and build within the application (e.g., game scene description, etc.).

Interactive analysis module 216 may receive interactions from the user interface of user device 200 that are detected by one or more sensors. User interface may enable user interactions at user device 200.

Display screen 220 may provide various display formats in response to user actions detected by a user interaction sensor associated with the user interface. User action data may be detected and transferred to processor 118.

The various engines or modules 210 may act as an interception layer for stereo or 3D rendering between game engine 214 and display 220. The various engines or modules 210 may be a post-processing mechanism which does not depend on the game engine 214, and can be transplanted with any game engine. The various engines or modules 210 may comprise two pipelines, including a single rendering pipeline and dual rendering pipeline, to provide 3D effect for applications that would not ordinarily support 3D images. Additional detail regarding the pipelines are provided with FIG. 3.

In some examples, this process may be detectible externally from the user device. For example, a sequence of calls to drivers 116 may be identified. These identified calls may be compared to a first sequence of calls when the 3D effects are activated and a second sequence of when the 3D effects are disabled. For example, advanced stereoscopic 3D rendering system 102 may acquire states such as depth, textures, and restore (e.g., the game developer or game engine). A user device that utilizes the advanced stereoscopic 3D rendering system 102 may include an extra application programming interface (API) call(s) to advanced stereoscopic 3D rendering system 102 and may be detectible by comparing the sequence of calls.

Interactive analysis module 216 may translate the user data to game engine readable data. Interactive data may be acquired via game engine 214 from the interactive analysis module 216. Game engine 214 may also include the 3D objects in the game scene description that are generated by stereoscopic 3D rendering engine 202. After rendering via rendering engine 212, the updated scene may be presented on display screen 220.

In some examples, a depth map can be generated. There may be several ways that the various engines or modules 210 can use computer vision and deep learning to estimate the depth from a 2D image for the depth map. For example, the generation of the depth may can be continuous or can be converted to a Layered Depth Image (LDI) based on a certain threshold value. In some examples, the depth map may be generated based on an indirect depth-map estimation process that learns the mapping between unpaired RGB-D images and arbitrary images to implicitly estimate the required depth-map (e.g., underwater, on-ground or terrestrial, etc.). The process may be based on principles of cycle-consistent learning and dense-block based auto-encoders as generator networks.

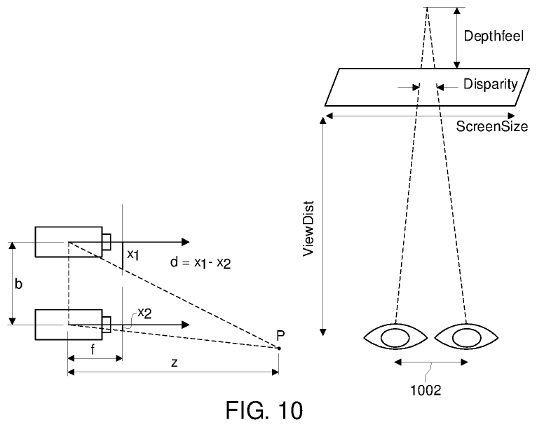

Other values may be considered in addition to a layout or separation of a user's eyes, including viewing distance, screen resolution, or screen diagonal length. These parameters can be fine-tuned based on feedback received regarding a best visual effect on a specific user devices or may be retrieved at runtime from the user device itself (e.g., stored in memory, associated with a user identifier, etc.). Equations to calculate these values are provided with FIG. 10 for illustrative purposes and should not be used to limit the disclosure.

In some examples, image inpainting may be used to improve the quality of the synthesized view, especially in cases where there has large disparity. The image may be generated by initiating an estimation process to compute pixel values around a particular pixel, sometimes referred to hallucination by the image inpainting method. The image inpainting method process may identify the particular pixel and, using deep learning algorithm, replace any portion of the image with the estimated pixel value. The inpainting method can correspond with traditional computer vision technology or neural network based on deep learning. The inpainting work can be implemented, for example, on color frames only or with the guidance of Layer Depth Image (LDI).

To get the parameters for computing disparity, a calibration of viewing parameters may be implemented. For user devices that include a front camera, the viewing distance and eye separation values can be obtained at runtime by deploying a face tracking module and/or detection module. For example, the face tracking module and/or detection module may implement a data gathering process of a plurality of samples of other faces (e.g., receiving a plurality of facial images, etc.), train the module (e.g., using the received images and respective identifiers of each face to train the module to detect standard components of faces, etc.), and then use the trained module to detect whether the user's face is present at the front camera. The user may provide their via the front camera so that the module can detect the face using the trained module. The face tracking module and/or detection module can add a rectangle image around the user's face to estimate the distance from the user's eye to the screen. The measurements determined from the front camera can be parsed to a 3D rendering pipeline for more accurate disparity computation. For user devices without a front camera (e.g., including a screen cover, devices that utilize magnifying lens based accessories for 3D viewing, lenticular lens, etc.), a one-time calibration may be implemented to adjust an interlacing angle with respect to the parallelism with lens. The calibration may be adjusted based on a distance. The calibration can be implemented as a separate process or a plug-in to graphics 112. The calibration can be initiated or reset by users at any time, and the adjusted parameters can be passed to the 3D rendering pipeline for rotating or shifting the interlaced views, as further illustrated with FIG. 3.

In some examples, a submodule may be implemented to remove artifacts from the processed 3D image. The submodule may include a guided filter module to determine texture and depth alignment and/or an edge preserving filter module. In the edge preserving filter module, the edges of an object can be identified in the image to confirm that the edges around cliff depth value regions are tightly aligned with the edges in the texture image (e.g., within a threshold value). The edge preserving filtering can leverage gradient information on both images to measure the similarity across the pixels. “Strong” edges may be identified (e.g., a gradient value exceeds a gradient threshold value, etc.). In some examples, the system may filter the value of depth when the gradient value difference is too large. This may help remove artifacts from the processed 3D image and improve the image quality at the user device.

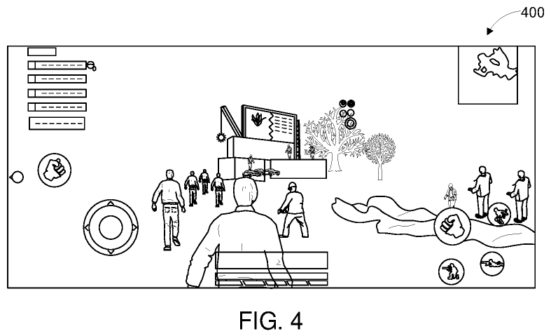

FIG. 3 illustrates the advanced stereoscopic 3D rendering system, in accordance with embodiments of the application. For example, advanced stereoscopic 3D rendering system 102 can provide two different pipelines, single rendering pipeline 302 and dual rendering pipeline 304, for different game engines. The use of single rendering pipeline 302 or dual rendering pipeline 304 may depend on the game engine that generated the initial 2D images. Advanced stereoscopic 3D rendering system 102 can generate different 3D data format that is received and provided for display by the user device. Advanced stereoscopic 3D rendering system 102 can provide various different 3D display formats, which are discussed throughout the disclosure, including at FIGS. 4-8 (e.g., anaglyph, side-by-side, interlace, 2*2 hydrogen 4-view (H4V) format, etc.). Using single rendering pipeline 302 or dual rendering pipeline 304, the stereoscopic 3D rendering engine can generate the 3D effect from the initial 2D image.

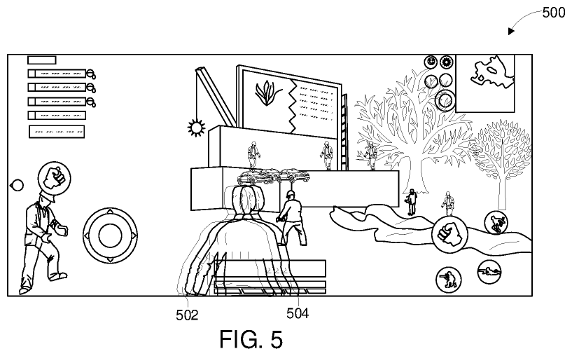

FIGS. 4-8 illustrate various images associated with advanced stereoscopic 3D rendering system 102, in accordance with embodiments of the application. Using these various image, the user perception of these images may be optimized to generate a 3D image from an original 2D image. For FIGS. 5-8, the 3D images may be generated from the original frame (a) (left view) and a latent synthesized view (right view).

FIG. 4 illustrates an original image 400, in accordance with embodiments of the application. The original image may be generated by the game engine and unaltered by advanced stereoscopic 3D rendering system 102.

FIG. 5 illustrates an anaglyph image 500, in accordance with embodiments of the application. The anaglyph image 500 may encode each eye's image using filters of different colors (e.g., like chromatically opposite colors including red and cyan, etc.). Anaglyph 3D images contain two differently filtered colored images, including left 502 and right 504 images (e.g., one for each eye). When viewed through the “color-coded”, “anaglyph glasses”, each of the two images 502, 504 reaches the eye it's intended for, revealing an integrated stereoscopic image. The visual cortex of the brain may fuse these images into the perception of a 3D scene or composition.

The anaglyph image may merge colors for different views. For example, the green and blue color channels of the view on the left 502 may be merged with the red channel of the view on the right 504 to form an anaglyph RGB stereo frame.

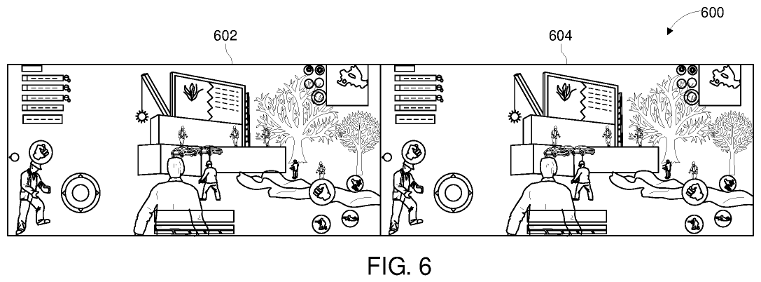

FIG. 6 illustrates a side-by-side image 600, in accordance with embodiments of the application. The side-by-side image may consist of two halves on the left 602 and right 604, where the entire frame for the left eye is scaled down horizontally to fit the left-half of the frame, and the entire frame for the right eye is scaled down horizontally to fit the right side of the frame. When the user device receives this side-by-side 3D signal, it may split each frame to extract the frame for each eye, and then rescale the individual frames to a full high definition (HD) resolution using upscaling algorithms. The user device may then display the upscaled individual frames alternately in a frame-sequential manner that is in sync with glasses (e.g., active shutter 3D glasses, etc.) worn by the user to view the 3D image.

The side-by-side image 600 may be downscaled. For example, the system may horizontally downscale the left view 602 and the right view 604 and put the two views in a side-by-side image that is stitched together in a frame.

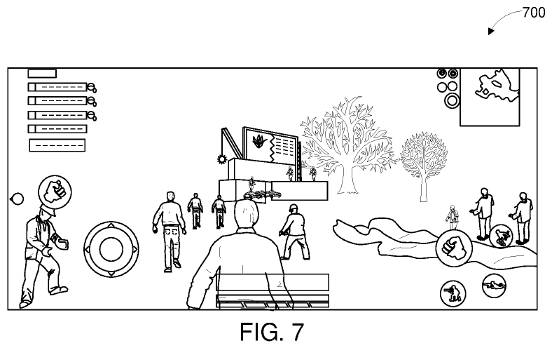

FIG. 7 illustrates an interlaced image 700, in accordance with embodiments of the application. The interlaced image 700 may be generated using spatial or temporal interlacing to send different images to the two eyes. For example, temporal interlacing may deliver images to the left and right eyes alternately in time. Spatial interlacing may deliver even pixel rows to one eye and odd rows to the other eye simultaneously.

Similar to the side-by-side image 600 in FIG. 6, the interlaced image 700 may also be downscaled. For example, the left view and right view may each be horizontally downscaled, but instead of being stitched side-by-side, the pixels in the two views may be column-wised interlaced, to form an image of interlaced view format.

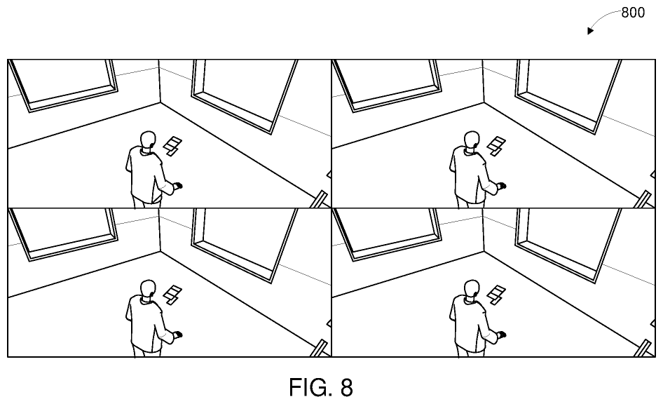

FIG. 8 illustrates a 2*2 H4V format image 800 (e.g., quad), in accordance with embodiments of the application. The 2*2 H4V format 800 may correspond with two images horizontally and two images vertically in an MPEG-4/AVC H.264 format. H.264 (e.g., MPEG-4 Part 10, or MPEG-4 Advanced Video Coding (AVC), etc.) may correspond with a video compression format that utilizes block-oriented motion-estimation-based codecs. In some examples, three frames are synthesized for the original frame (top left image), and stitched together in a two-by-two format.

Returning to FIG. 3, a single rendering pipeline 302 may be implemented. For example, single rendering pipeline 302 may receive one or more calibration parameters 310 (e.g., from a game developer or game engine) and game input 312 (e.g., texture, depth, etc.). Single rendering pipeline 302 may initiate a disparity computation, 3D warping, and post processing (using depth filtering). The output of single rendering pipeline 302 may be provided in one or two images and rendered to a display screen of the user device.

In some examples, DIBR may be used to synthesize virtual views of the scene from texture information with associated depth information. For example, the synthesize approach can be understood by first warping the points on the original image plane to the 3D world coordinates and then back-projecting the real 3D points onto the virtual image plane which is located at the required viewing position defined by user at the receiver side. For DIBR purposes, it is assumed that all camera calibration data, the quantization parameters, and the 3D position of the convergence point are transmitted as metadata and are known at the receiver side.

In some examples, an anaglyph may be used to synthesize a second view. The anaglyph image may correspond with a stereoscopic 3D effect achieved by encoding each eye's image using filters of different colors (e.g., like chromatically opposite colors including red and cyan, etc.). An initial 2D image is provided with FIG. 4 and an illustrative anaglyph image is provided with FIG. 5, for illustrative purposes. The anaglyph 3D images contain two differently filtered colored images, one for each eye. When viewed through the “color-coded” “anaglyph glasses”, each of the two images reaches the eye it's intended for, revealing an integrated stereoscopic image. The visual cortex of the brain fuses this into the perception of a three-dimensional scene or composition. In an illustrative example, the red channel of input image is used as left view and the green and blue channel is used as right view, yet any iteration of colors may be implemented in various embodiments.

Dual rendering pipeline 304 may also be implemented, based on the user device that ultimately provides the output 3D image. For example, dual rendering pipeline 304 may receive game input 312 (e.g., texture, depth, etc.). Dual rendering pipeline 304 may determine an initial camera position, set transform parameters, and shift the initial camera position of the virtual camera (using depth filtering). The output of dual rendering pipeline 304 may be provided in one or two images and rendered to a display screen of the user device.

For example, a virtual camera in openGL may be shifted to generate an additional view. In order to move the camera, advanced stereoscopic 3D rendering system 102 may modify uniform buffers that contain the camera position and any dependent transforms used by the shader modules. This process may be applied without access to the source code of the application (e.g., the electronic game). In some examples, the advanced stereoscopic 3D rendering system may reverse-engineer the uniform buffers and create heuristics to identify them. The heuristics may vary between game engines, applications, and perhaps even between applications using the same engine.

In some examples, the uniform buffers that contain the camera position data may be modified. For example, in a 3D game application, the parameters of the virtual camera may be stored in the uniform buffer of a game engine. The uniform buffers may be queried and searched by advanced stereoscopic 3D rendering system 102. Using output from the search queries, the parameters can be used by OpenGL shader. The parameters may be passed to the shader as uniform buffers, which are the input/output parameters specified in OpenGL.

Dual rendering pipeline 304 may not generate another view. For example, as illustrated in FIG. 2, multiple views may be received from game engine 214 at stereoscopic 3D rendering engine 202 (e.g., based on a query search or request in view of the disparity of missing data) and used to generate the view. In some examples, dual rendering pipeline 304 may consume more power than single rendering pipeline 302 but may provide better visual quality for the user.

In some examples, both the multi-view capturing system and rendering system utilize the same 3D coordinates such that the relative positions between the real cameras of the capturing system and the virtual cameras of the 3D display system are coordinated for further processing. Based on geometric relations, the rendering process chain can follow different steps of single rendering pipeline 302 or dual rendering pipeline 304.

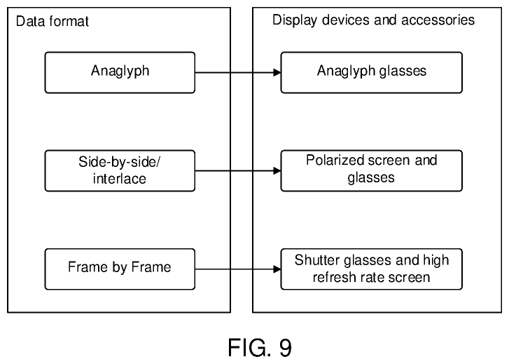

FIG. 9 illustrates providing each image type from a data format to a corresponding user device, in accordance with embodiments of the application. Each of these user devices may display the 3D effect. For example, an anaglyph image (e.g., illustrated in FIG. 5) may be provided to a user device that incorporates anaglyph glasses. For this data format, the user device may provide each of the two colored images to correspond with the eye that the color is intended for to create the 3D effect (e.g., a left image on the left side of the screen and a right image on the right side of the screen). In another example, a side-by-side or interlaced image (e.g., illustrated in FIGS. 6 and 7, respectively) may be provided to a user device that incorporates a polarized screen and/or glasses. In another example, a frame by frame data format (e.g., illustrated in FIG. 8) may be provided to a user device that incorporates shutter glasses and a high refresh rate screen.

FIG. 10 provides an illustrative disparity calculation, in accordance with embodiments of the application. For example, the units may be measured in pixels to determine the disparity. The disparity may be inversely proportional to depth, where x1 and x2 are two pixels from right and left view respectively, d=x1−x2 is disparity, f is the view distance, b is interpupillary distance 1002.

In some examples, the disparity may also be computed. The following equations may be used.

$$pixToInch = \frac{screenDiag}{\sqrt{screenSize . {x}^{2} + screenSize . {y}^{2}}} .$$

Where “pixToInch” defines the inch number computed from a pixel number, “screenDiag” defines the inch number of screen diagonal distance, “screenSize” defines a rectangle of the screen, “x” defines the screen width in inches, and “y” defines the screen height in inches.

$$texToGL = \frac{\sqrt{2}}{\sqrt{screenSize . {x}^{2} + screenSize . {y}^{2}}}$$

Where “texToGL” defines the transformation from graphics coordinate to texture coordinate, “screenSize” defines the screen dimension in inch, “x” defines the width, and “y” defines the height.

$$sceenDisparity = \frac{depthFeel \times eyeSep}{depthFeel + viewDist} .$$

Where “sceenDisparity” defines the pixel offset distance (e.g., in inches) when displaying on a screen, “depthFeel” defines the perceived distance (e.g., in inches) when view 3D displaying, “eyeSep” defines the distance between the centers of two eyes (e.g., in inches), and “viewDist” defines the distance from eyes to the screen (e.g., in inches).

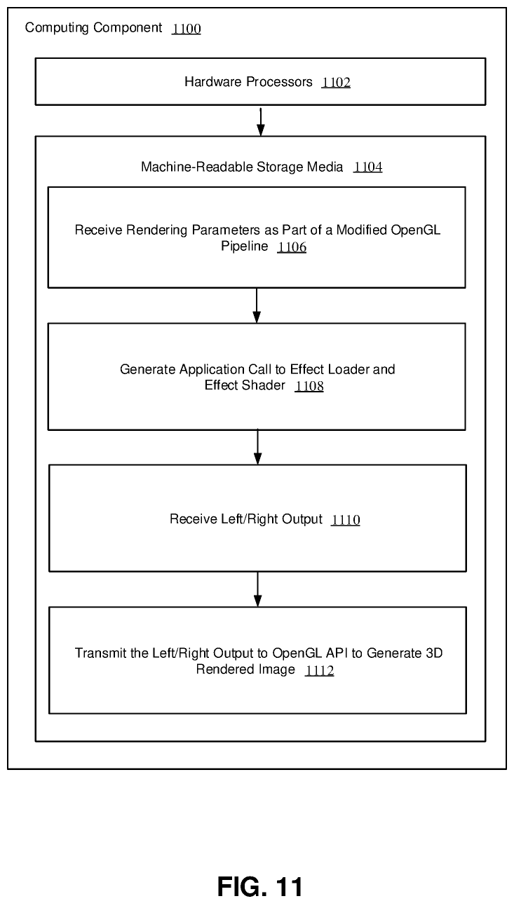

FIG. 11 illustrates an example iterative process performed by a computing component 1100 for providing stereoscopic rendering. Computing component 1100 may be, for example, a server computer, a controller, or any other similar computing component capable of processing data. In the example implementation of FIG. 11, the computing component 1100 includes a hardware processor 1102, and machine-readable storage medium 1104. In some embodiments, computing component 1100 may be an embodiment of a system corresponding with advanced stereoscopic 3D rendering system 102 of FIG. 1.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1106-1112, to control processes or operations for optimizing the system during run-time. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1106-1112.

Hardware processor 1102 may execute instruction 1106 to receive rendering parameters. For example, hardware processor 1102 may receive rendering parameters provided as part of a modified OpenGL pipeline in an interception layer to an original application. In some examples, the original application may be a two-dimensional (2D) game.

In some examples, the rendering parameters define a single rendering mode or a dual rendering mode. The single rendering mode may initiate a disparity computation, 3D warping, and post processing alignment and inpainting to determine the left output and the right output. The dual rendering mode may determine an initial camera position, set transform parameters, and shift the initial camera position to determine the left output and the right output.

Hardware processor 1102 may execute instruction 1108 to generate an application call. For example, hardware processor 1102 may generate an application call request to an effect loader and an effect shader. In some examples, the effect loader comprises a 3D library of 3D objects.

Hardware processor 1102 may execute instruction 1110 to receive left and/or right output. For example, hardware processor 1102 may, in response to the application call request, receive an application call response for a left output and a right output. In some examples, the application call response is generated in consideration of a layout of the user's eyes using a disparity measurement.

Hardware processor 1102 may execute instruction 1112 to transmit output. For example, hardware processor 1102 may transmit the left output and the right output to an OpenGL application programming interface (API) to create a three-dimensional (3D) rendered image in the original application.

In some examples, the rendering parameters define a single rendering mode or a dual rendering mode. In some examples, the single rendering mode initiates a disparity computation, 3D warping, and post processing alignment and inpainting to determine the left output and the right output. In some examples, the dual rendering mode determines an initial camera position, sets transform parameters, and shifts the initial camera position to determine the left output and the right output.

In some examples, the original application is a two-dimensional (2D) game.

In some examples, the effect loader comprises a 3D library of 3D objects.

In some examples, the application call response is generated in consideration of a layout of the user's eyes using a disparity measurement.

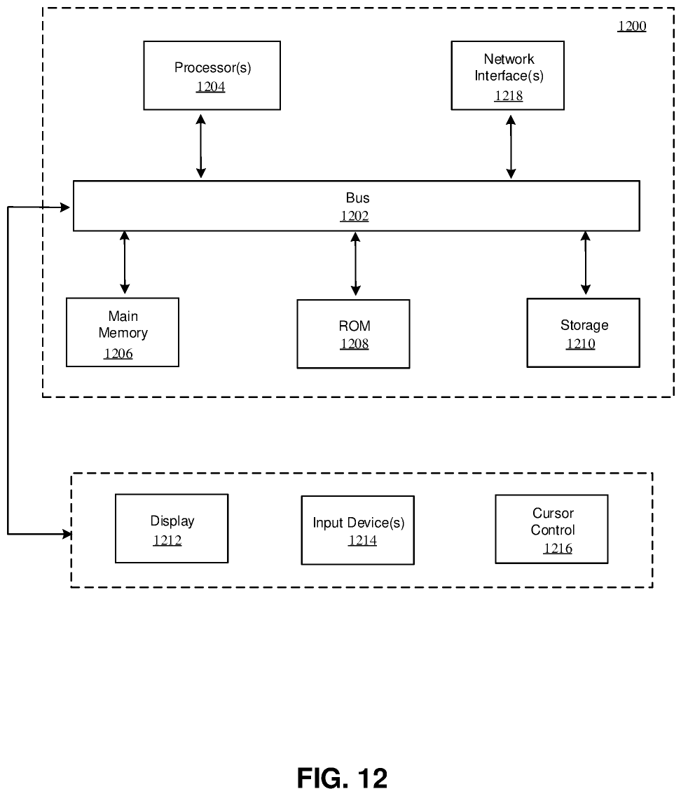

FIG. 12 depicts a block diagram of an example computer system 1200 in which various of the embodiments described herein may be implemented. The computer system 1200 includes a bus 1202 or other communication mechanism for communicating information, one or more hardware processors 1204 coupled with bus 1202 for processing information. Hardware processor(s) 1204 may be, for example, one or more general purpose microprocessors.

The computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions.

The computer system 1200 further includes a read only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

The computer system 1200 may be coupled via bus 1202 to a display 1212, such as a liquid crystal display (LCD) (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. In some embodiments, the same direction information and command selections as cursor control may be implemented via receiving touches on a touch screen without a cursor.

The computing system 1200 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component”, “engine”, “system”, “database”, data store”, and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor(s) 1204 executing one or more sequences of one or more instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative embodiments, hard-wired circuitry may be used in place of or in combination with software instructions.

The term “non-transitory media”, and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1210. Volatile media includes dynamic memory, such as main memory 1206. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1202. Transmission media can also take the form of acoustic or light waves, such as those generated during radio-wave and infra-red data communications.

The computer system 1200 also includes a communication interface 1218 coupled to bus 1202. Communication interface 1218 provides a two-way data communication coupling to one or more network links that are connected to one or more local networks. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN (or WAN component to communicated with a WAN). Wireless links may also be implemented. In any such implementation, communication interface 1218 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1218, which carry the digital data to and from computer system 1200, are example forms of transmission media.

The computer system 1200 can send messages and receive data, including program code, through the network(s), network link and communication interface 1218. In the Internet example, a server might transmit a requested code for an application program through the Internet, the ISP, the local network and the communication interface 1218.

The received code may be executed by processor 1204 as it is received, and/or stored in storage device 1210, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1200.

As used herein, the term “or” may be construed in either an inclusive or exclusive sense. Moreover, the description of resources, operations, or structures in the singular shall not be read to exclude the plural. Conditional language, such as, among others, “can”, “could”, “might”, or “may”, unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional”, “traditional”, “normal”, “standard”, “known”, and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more”, “at least”, “but not limited to” or other like phrases in some instances shall not be read to mean that the narrower case is intended or required in instances where such broadening phrases may be absent.

What is claimed is:

1. A computer-implemented method comprising:
receiving rendering parameters provided as part of a modified OpenGL pipeline in an interception layer to an original application;
generating an application call request to an effect loader and an effect shader;
in response to the application call request, receiving an application call response for a left output and a right output; and
transmitting the left output and the right output to an OpenGL application programming interface (API) to create a three-dimensional (3D) rendered image in the original application.

2. The computer-implemented method of claim 1, wherein the rendering parameters define a single rendering mode or a dual rendering mode.

3. The computer-implemented method of claim 2, wherein the single rendering mode initiates a disparity computation, 3D warping, and post processing alignment and inpainting to determine the left output and the right output.

4. The computer-implemented method of claim 2, wherein the dual rendering mode determines an initial camera position, sets transform parameters, and shifts the initial camera position to determine the left output and the right output.

5. The computer-implemented method of claim 1, wherein the original application is a two-dimensional (2D) game.

6. The computer-implemented method of claim 1, wherein the effect loader comprises a 3D library of 3D objects.

7. The computer-implemented method of claim 1, wherein the application call response is generated in consideration of a layout of the user's eyes using a disparity measurement.

8. A computer system for generating a three-dimensional (3D) rendered image comprising:
a memory; and
one or more processors that are configured to execute machine readable instructions stored in the memory to:
receive rendering parameters provided as part of a modified OpenGL pipeline in an interception layer to an original application;
generate an application call request to an effect loader and an effect shader;
in response to the application call request, receive an application call response for a left output and a right output; and
transmit the left output and the right output to an OpenGL application programming interface (API) to create the 3D rendered image in the original application.

9. The computer system of claim 8, wherein the rendering parameters define a single rendering mode or a dual rendering mode. The computer system of claim 9, wherein the single rendering mode initiates a disparity computation, 3D warping, and post processing alignment and inpainting to determine the left output and the right output.

11. The computer system of claim 9, wherein the dual rendering mode determines an initial camera position, sets transform parameters, and shifts the initial camera position to determine the left output and the right output.

12. The computer system of claim 8, wherein the original application is a two-dimensional (2D) game.

13. The computer system of claim 8, wherein the effect loader comprises a 3D library of 3D objects.

14. The computer system of claim 8, wherein the application call response is generated in consideration of a layout of the user's eyes using a disparity measurement. A non-transitory computer-readable storage medium storing a plurality of instructions executable by one or more processors, the plurality of instructions when executed by the one or more processors cause the one or more processors to:
receive rendering parameters provided as part of a modified OpenGL pipeline in an interception layer to an original application;
generate an application call request to an effect loader and an effect shader;
in response to the application call request, receive an application call response for a left output and a right output; and
transmit the left output and the right output to an OpenGL application programming interface (API) to create the 3D rendered image in the original application.

16. The computer-readable storage medium of claim 15, wherein the rendering parameters define a single rendering mode or a dual rendering mode.

17. The computer-readable storage medium of claim 16, wherein the single rendering mode initiates a disparity computation, 3D warping, and post processing alignment and inpainting to determine the left output and the right output.

18. The computer-readable storage medium of claim 16, wherein the dual rendering mode determines an initial camera position, sets transform parameters, and shifts the initial camera position to determine the left output and the right output.

19. The computer-readable storage medium of claim 15, wherein the original application is a two-dimensional (2D) game.

20. The computer-readable storage medium of claim 15, wherein the effect loader comprises a 3D library of 3D objects.
